(19) United States
(12) Patent Application Publication
(10) Pub. No.: US 2025/0021819 A1
(43) Pub. Date: Jan. 16, 2025

(54) SYSTEMS, METHOD, AND APPARATUS FOR QUALITY AND CAPACITY-AWARE GROUPED QUERY ATTENTION

(71) Applicant: Intel Corporation, Santa Clara, CA (US)

(72) Inventors: Vinay Joshi, Nanded (IN); Om Ji Omer, Bangalore (IN); Prashant Laddha, Bangalore (IN); Shambhavi Sinha, Bangalore (IN)

(73) Assignee: Intel Corporation, Santa Clara, CA (US)

(21) Appl. No.: 18/900,006

(22) Filed: Sep. 27, 2024

(30) Foreign Application Priority Data
Jun. 8, 2024 (IN) 202441044447

(51) Int. Cl. G06N 3/086

(52) U.S. Cl. CPC G06N 3/086

(57) ABSTRACT

Systems, apparatus, articles of manufacture, and methods for quality and capacity-aware grouped query attention are disclosed. To accomplish such groupings, example instructions cause a machine to create a plurality of groups of query heads present in a key value cache using an evolutionary algorithm based on at least two objectives, quantify an amount of error introduced by a first group of query heads in the plurality of groups of query heads, and retain the query heads of the first group of query heads in a non-grouped arrangement when the error meets an error threshold.

### RELATED APPLICATION

This patent claims the benefit of India Provisional Patent Application No. 202441044447, which was filed on Jun. 8, 2024. India Provisional Patent Application No. 202441044447 is hereby incorporated herein by reference in its entirety. Priority to India Provisional Patent Application No. 202441044447 is hereby claimed.

### BACKGROUND

Autoregressive text generation in a large language model (LLM) generates text outputs by processing an input prompt and all previous output tokens to generate the next output token. Caching key and value features in a cache (KV-cache) at each generation step as they get computed along the generation process enables the LLM to generate text outputs quickly without having to recompute information that has already been computed. This reduces the number of computations in autoregressive processing at the cost of increased capacity requirement for caching Key and Value features.

### BRIEF DESCRIPTION OF THE DRAWINGS

FIG. 1 is a block diagram illustrating groupings of query heads using existing techniques, as contrasted with the techniques of the instant disclosure.

FIG. 2 is a block diagram illustrating Quality and Capacity-Aware Grouped Query Attention (QCQA).

FIG. 3 is a block diagram of an example implementation of model execution circuitry for execution of a machine learning model utilizing query head grouping as disclosed herein.

FIG. 4 is a flowchart representative of example machine readable instructions and/or example operations that may be executed, instantiated, and/or performed by example programmable circuitry to implement the model execution circuitry of FIG. 3.

FIG. 5 is a flowchart representative of example machine readable instructions and/or example operations that may be executed, instantiated, and/or performed by programmable circuitry to perform reduction of a KV cache.

FIG. 6 is a diagram illustrating assignment of query heads to various groups using an arbitrary cardinality implementation.

FIG. 7 is a diagram illustrating assignment of query heads to various groups using an equal cardinality implementation.

FIG. 8 is an example algorithm 800 that may be used to implement grouping of query heads using an evolutionary algorithm (EA) approach.

FIG. 9 represents an approach for selecting layers to preserve the grouping information.

FIG. 10 illustrates task accuracy achieved using the example approaches disclosed herein across varying sizes of a KV-cache.

FIG. 11 is a block diagram of an example processing platform including programmable circuitry structured to execute, instantiate, and/or perform the example machine readable instructions and/or perform the example operations of FIGS. 4 and/or 5 to implement the model execution circuitry 300 of FIG. 3.

FIG. 12 is a block diagram of an example implementation of the programmable circuitry of FIG. 11.

FIG. 13 is a block diagram of another example implementation of the programmable circuitry of FIG. 11.

FIG. 14 is a block diagram of an example software/firmware/instructions distribution platform (e.g., one or more servers) to distribute software, instructions, and/or firmware (e.g., corresponding to the example machine readable instructions of FIGS. 4 and/or 5) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

Large Language Models (LLMs) have achieved remarkable performance across various natural language processing tasks. Consequently, they are widely used in real-time applications such as programming, chatbots, and content creation, including image, text, and music generation. Autoregressive inference, which underpins these applications, often utilizes caching past key and value features for future token computation. Such key and value features are commonly stored in a KV-cache. The size of this KV-cache increases linearly with the mini-batch size, input sequence length, number of heads per layer, and number of layers. In several practical applications, the KV-cache has grown more than double the size of LLM parameters. The growing complexity of language modeling tasks leads to LLMs with a higher number of attention layers and heads per layer to process longer input sequence lengths. This leads to significant increases in KV-cache size, often exceeding the size of the model parameters, especially when the mini-batch size is increased to attempt to improve throughput. Excessive memory requirements of key and value features present significant challenges in the autoregressive inference of LLMs, restricting both the speed and length of text generation. Memory accesses to large KV-cache data sets becomes a bottleneck in autoregressive LLM inference, adversely impacting the latency, throughput, and energy consumed for token generation.

Autoregressive inference in LLMs is often impacted by the repetitive loading of key and value features for computing the next output token. Uncontrolled growth in KV-cache due to increasing mini-batch size or input sequence length could exceed the size of LLM parameters (weights) per se. Sharing-based attention acceleration shrinks head dimension by arranging multiple Query heads in different groups and often mean-pools corresponding key and value heads. For a mini-batch size B, input sequence length T, and H number of heads both key and value features per attention layer have dimension key ∈ [symbol] ^{[B,T,H,d}^{ₖ}^{]} and value ∈ [symbol] ^{[B,T,H,d}^{ᵥ}^{]}, respectively. The head dimension of model weights corresponding to key (W_{K}∈ [symbol] ^{[H, d}^{_{K}}^{,,d}^{_{model}}^{]}) and value (W_{V}∈ [symbol] ^{[H, d}^{ᵥ}^{,,d}^{_{model}}^{]}) features is reduced to shrink the KV-cache size. dₖ, dᵥ, and d_{model} are feature dimensions of key, value, and model, respectively. Either of the four dimensions can be shrunk to reduce the overall KV-cache memory requirements. However, reducing the mini-batch size impacts the throughput of LLM execution on the hardware. Decreasing the number of input tokens affects the model's performance on longer sequences. Hence a more natural choice is to reduce the KV-cache capacity by decreasing the number of heads.

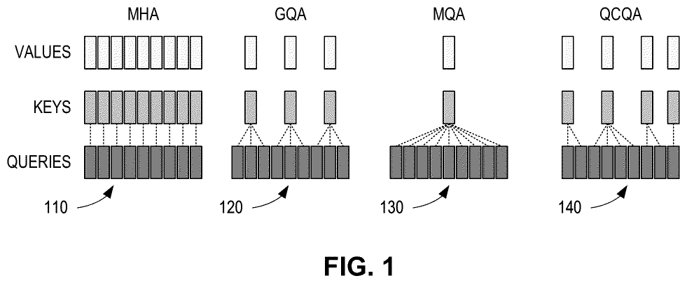

FIG. 1 is a block diagram illustrating groupings of query heads using existing techniques, as contrasted with the techniques of the instant disclosure. FIG. 1 includes a representation of data stored in a KV-cache using multi-head attention (MHA) 110, a representation of data stored in a KV-cache using Grouped Query Attention (GQA) 120, a representation of data stored in a KV-cache using multi-Query Attention (MQA) 130. Lastly, FIG. 1 includes a representation of data stored in a KV-cache utilizing the techniques disclosed herein, which throughout this disclosure is referred to as Quality and Capacity-Aware Grouped Query Attention (QCQA) 140.

In LLMs, attention mechanisms have been utilized to enable a large language model to focus on particular portions of an input (e.g., the KV cache) when preparing an output. Varying weights (i.e., attention scores) are applied to different tokens in a sequence, which enables an LLM to identify which portions are more important when generating a subsequent out. Multi-head attention (MHA) 110 enables a model to focus on different parts of a sequence (e.g., a KV cache) in parallel. However, the MHA approach 110 suffers from an increasing size of KV-cache, which becomes a bottleneck in LLM inference.

Some known techniques attempt to optimize KV-cache size requirements, including reduced precision, retaining only significant keys and values, and grouped attention, which involves sharing key and value features across multiple query heads. Two prominent grouped attention methods are Multi-Query Attention (MQA) 130 and Grouped-Query Attention (GQA) 120. MQA consolidates all query heads into a single group, using one key (and value) head per layer. GQA, a generalization of MQA, divides query heads into multiple groups of equal size, with each group sharing a single key (and value) head. GQA has witnessed widespread adoption in popular LLM models such as Llama 2, Llama 3, Mistral, Gemma, Starcoder, and Meditron. MQA proposed full training, while GQA requires additional retraining (uptraining and/or fine-tuning) for 5-10% of training steps compared to full training to reduce the loss in accuracy. In some examples, the additional time and resource-intensive training required in MQA and GQA can also be prohibitive.

Unfortunately, MQA 130 and GQA 120 cannot guarantee an optimal tradeoff between KV-cache size and LLM accuracy. For example, MQA and GQA lack quality and capacity-aware grouping of query heads. Moreover, when grouping heads using MQA and GQA, the constraint of equally sized groups of consecutive heads could force two heads with highly distinct distribution into the same group.

Simply attempting to determine a preferred grouping through brute force evaluation of all possible combinations of grouping is impractical due to the enormous number of candidate groupings, represented by the Stirling number of the second kind S(H, P) for H number of heads and P groups. For instance, in the Llama2 7B model, arranging 32 heads into 4 groups can be done in S(32, 4)≈7×10¹⁷ ways. Beyond the vast search space, the computational expense of evaluating LLM accuracy for each candidate grouping presents a significant challenge.

Shrinking of head dimensions for LLM inference acceleration bears some similarities to neural architecture search (NAS) commonly used in optimizing deep neural network model architecture. For example, when attempting to arrange Query heads into distinct groups, there is an exhaustively large search space. Examples disclosed herein utilize an evolutionary algorithm (EA) based NAS for convolution neural network (CNN) architecture search to enable efficient deployment. As used herein, an evolutionary algorithm is an optimization process that utilizes mutation, recombination, etc. to modify a population of values (e.g., query heads in a key value cache) based on one or more objectives. A major bottleneck in using EA for architecture search is expensive candidate evaluations due to training or inference. Previous research has employed predictor functions to estimate the accuracy of a given CNN architecture to eliminate expensive inference runs, albeit at the cost of running expensive inference to collect data for supervised training of a predictor function.

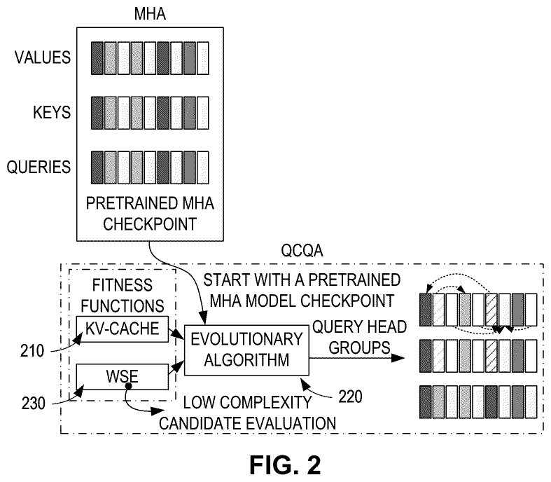

FIG. 2 is a block diagram illustrating Quality and Capacity-Aware Grouped Query Attention (QCQA) 140. Systems, methods, and apparatus disclosed herein implement Quality and Capacity-Aware Grouped Query Attention (QCQA) 140, which identifies optimal query head groupings by at least one of (1) clustering based on significance scores of KV heads in a KV cache 210 or (2) utilizing an evolutionary algorithm 220 with a computationally efficient and inexpensive fitness function. The example approaches disclosed herein operate based on query heads created using multi-head attention (MHA) 110. The example QCQA approaches disclosed herein reduce both accuracy loss and KV-cache capacity through a careful choice of layers and query heads for grouping. Unlike MQA and GQA, the examples disclosed herein can create arbitrarily sized groups of query heads using clustering based on significance scores of KV heads or an evolutionary algorithm. To circumvent the need for expensive LLM accuracy computations, QCQA employs a simple and computationally efficient fitness function that reliably indicates potential accuracy loss.

Systems, methods, and apparatus implementing QCQA provide a quality and capacity-aware grouping of query heads within and across layers for an optimal tradeoff between LLM accuracy and KV-cache size. In some examples, QCQA applies an evolutionary algorithm to forms groups of query heads with arbitrary cardinality. In some examples, QCQA applies an evolutionary algorithm to form groups of query heads with equal cardinality. Some example systems, methods, and apparatus implementing QCQA eliminate the need for computational expensive LLM evaluations utilizing an inexpensive fitness estimate, weight-sharing error 230, as a reliable indicator of LLM accuracy drop. QCQA utilizes non-uniform grouping of Query heads to reduce the KV-cache memory requirements without compromising LLM text generation quality. The weight matrices corresponding to the Key (Value) heads of Query features in a group are mean-pooled into a single Key (Value) head. Unlike MQA and GQA which use fixed and uniform grouping of query heads, QCQA forms non-uniform groups of Query heads by optimizing for KV-cache capacity and text-generation quality using either clustering based on significance score of KV heads or evolutionary search.

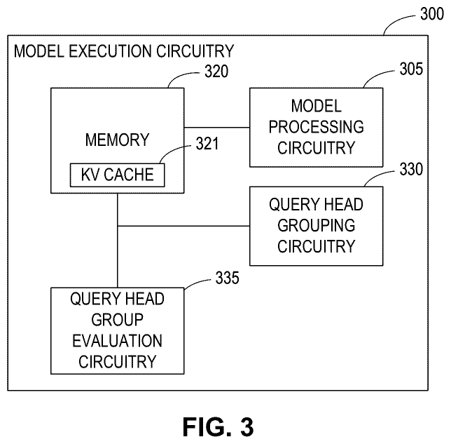

FIG. 3 is a block diagram of an example implementation of model execution circuitry 300 for execution of a machine learning model utilizing query head grouping as disclosed herein. The model execution circuitry 300 of FIG. 3 may be instantiated (e.g., creating an instance of, bring into being for any length of time, materialize, implement, etc.) by programmable circuitry such as a Central Processor Unit (CPU) executing first instructions. Additionally or alternatively, the model execution circuitry 300 of FIG. 3 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 3 may, thus, be instantiated at the same or different times. Some or all of the circuitry of FIG. 3 may be instantiated, for example, in one or more threads executing concurrently on hardware and/or in series on hardware. Moreover, in some examples, some or all of the circuitry of FIG. 3 may be implemented by microprocessor circuitry executing instructions and/or FPGA circuitry performing operations to implement one or more virtual machines and/or containers.

The example model execution circuitry 300 of FIG. 3 includes model processing circuitry 305, memory 320 which stores a KV cache 321, query head grouping circuitry 330, and query head group evaluation circuitry 335.

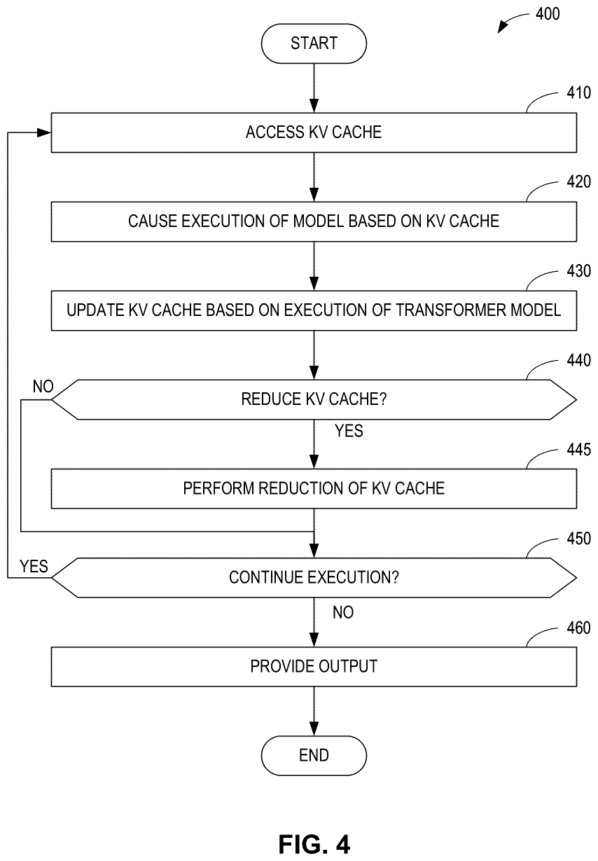

The example model processing circuitry 305 of the illustrated example of FIG. 3 accesses the KV cache 321 for execution of a model and executes the model using the information stored in the KV cache. As a result of the execution of the model, a new token to be added to (e.g., appended to) the KV cache will be created. The example model processing circuitry 305 updates the KV cache based on the execution of the model. In some examples, the model processing circuitry 305 is instantiated by programmable circuitry executing model processing instructions and/or configured to perform operations such as those represented by the flowchart of FIG. 4.

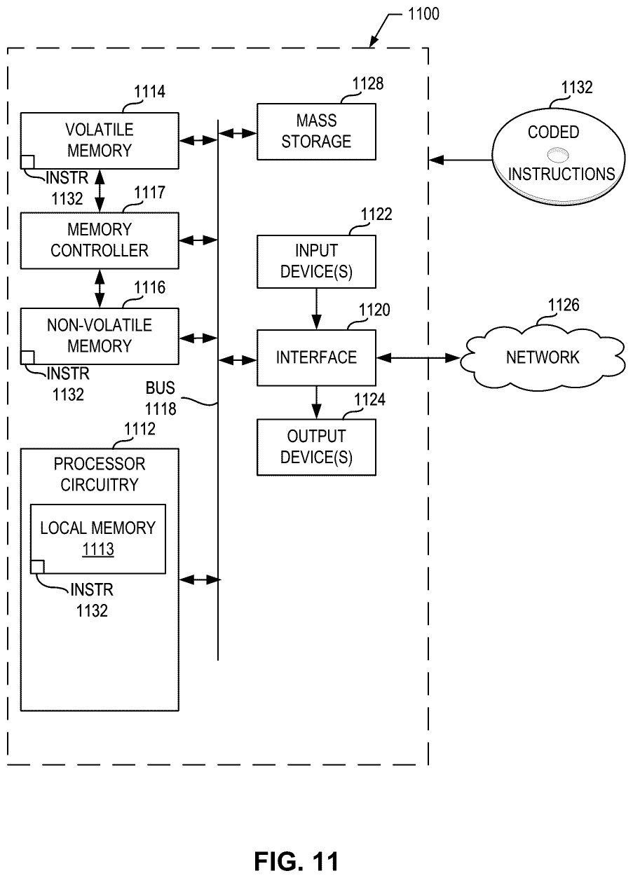

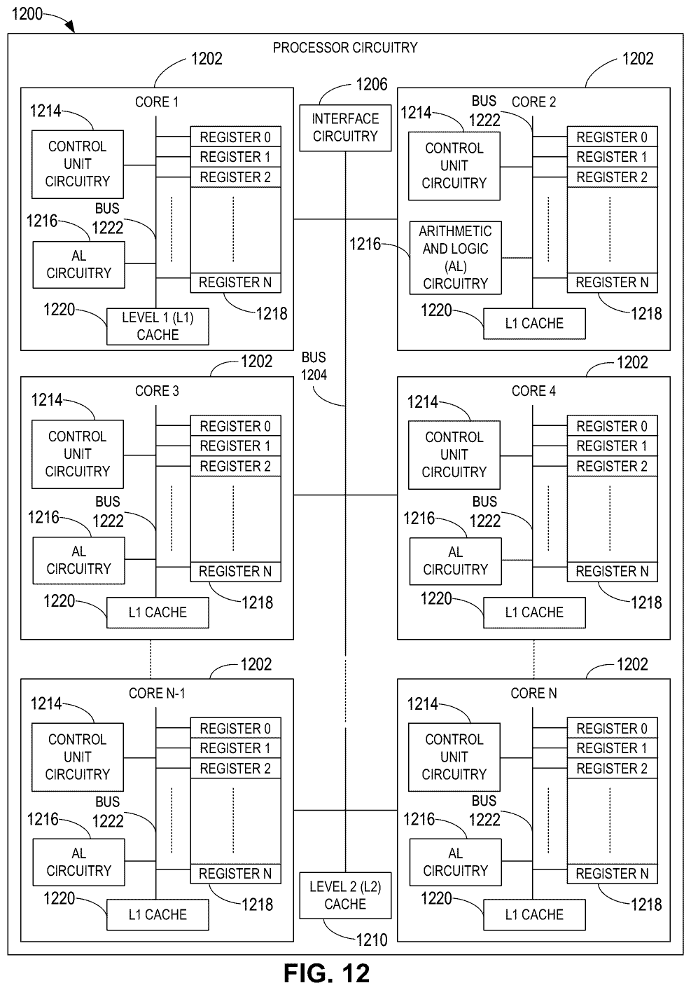

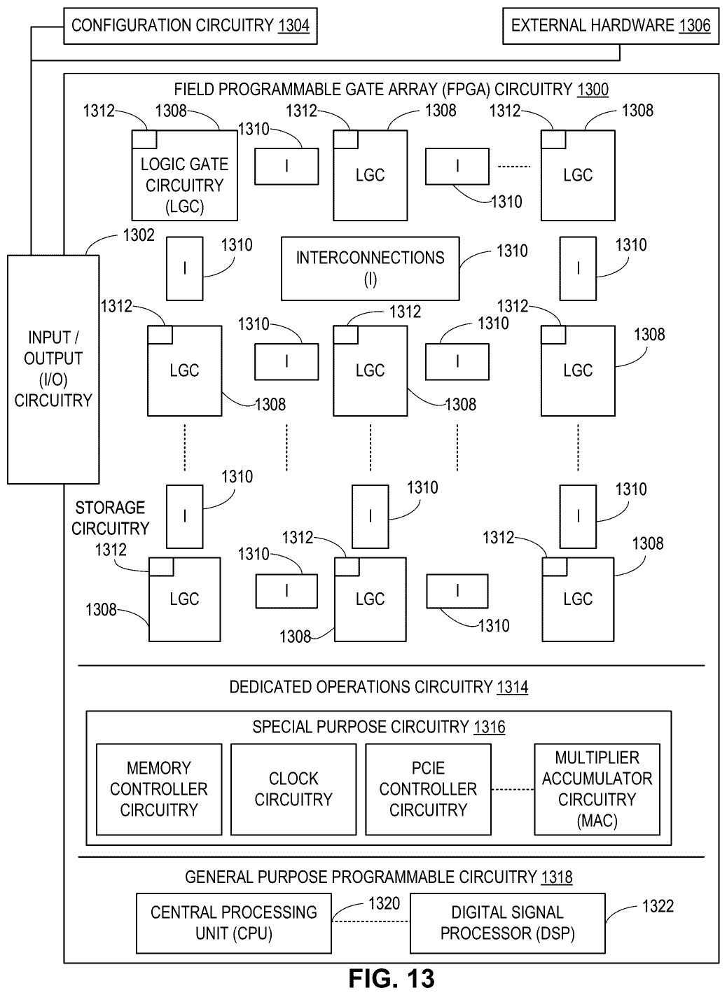

In some examples, the model execution circuitry 300 includes means for executing a machine learning model. For example, the means for executing may be implemented by model processing circuitry 305. In some examples, the model processing circuitry 305 may be instantiated by programmable circuitry such as the example programmable circuitry 1112 of FIG. 11. For instance, the model processing circuitry 305 may be instantiated by the example microprocessor 1200 of FIG. 12 executing machine executable instructions such as those implemented by at least blocks 410, 420, 430 of FIG. 4. In some examples, the model processing circuitry 305 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the model processing circuitry 305 may be instantiated by any other combination of hardware, software, and/or firmware. For example, the model processing circuitry 305 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example memory 320 of the illustrated example of FIG. 3 is implemented by a hardware memory device. Such memory 320 represents the actual storage space on the device where data (e.g., input and/or output tensors) and instructions are stored. The memory 320 is typically made up of multiple memory chips or devices that work together to provide a large amount of high-speed, low-latency access to data. The physical memory can be accessed directly by a processor (e.g., the model processing circuitry 305, the query head grouping circuitry 330, the query head group evaluation circuitry 335) and/or other components in the device. While in the illustrated example of FIG. 3, the memory 320 is illustrated as a single entity, such memory can be further divided into smaller units such as pages or blocks for better management and organization. In the illustrated example of FIG. 3, the memory 320 stores the KV cache 321.

The example query head grouping circuitry 330 of the illustrated example of FIG. 3 attempts to perform the reduction of the KV cache by forming groups of query heads. The example query head grouping circuitry 330 may accomplish grouping of query heads in two different ways. As a first approach, KV heads may be grouped by the query head grouping circuitry 330 based on significance score clustering. Alternatively, an evolutionary algorithm may be utilized to form groups of query heads. In practice, the evolutionary algorithm approach might be selected for use on more performant computing systems such as servers, cloud computing infrastructures, and high-end workstations. In contrast, significance score clustering might be used on less performant computing systems such as mobile devices, laptops, tablets, etc.

In some examples, the example query head grouping circuitry 330 is instantiated by programmable circuitry executing query head grouping instructions and/or configured to perform operations such as those represented by the flowchart(s) of FIGS. 4 and/or 5.

In some examples, the model execution circuitry 300 includes means for grouping query heads. For example, the means for grouping may be implemented by query head grouping circuitry 330. In some examples, the query head grouping circuitry 330 may be instantiated by programmable circuitry such as the example programmable circuitry 1112 of FIG. 11. For instance, the query head grouping circuitry 330 may be instantiated by the example microprocessor 1200 of FIG. 12 executing machine executable instructions such as those implemented by at least blocks 440, 445, 510 of FIGS. 4 and/or 5. In some examples, the query head grouping circuitry 330 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the query head grouping circuitry 330 may be instantiated by any other combination of hardware, software, and/or firmware. For example, the query head grouping circuitry 330 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

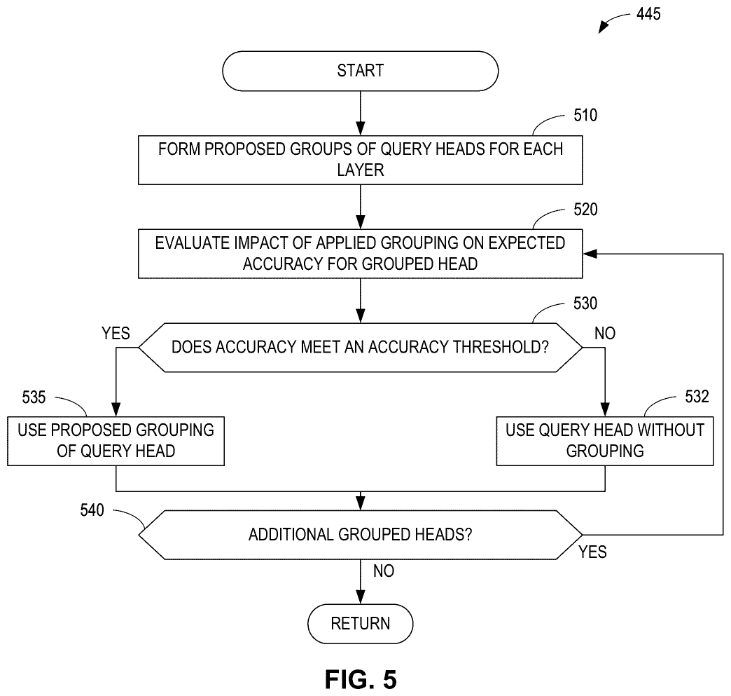

While the example query head grouping circuitry 330 described above attempts to form proposed groups of query heads for each layer in the KV-cache, and such proposed groups of query heads reduce KV-cache utilization, some of the proposed groups of query heads might adversely impact accuracy of the model. To handle the tradeoff between KV-cache size and LLM accuracy, the example query head group evaluation circuitry 335 evaluates the impact of the proposed group on accuracy of the model. If the grouped head does not result in an accuracy threshold being met, the query head group evaluation circuitry 335 retains the heads of the proposed group in their non-grouped format. If the accuracy threshold is met, the proposed grouping is used by the query head group evaluation circuitry 335, and subsequent proposed groups are evaluated, if such groups exist. In some examples, the query head group evaluation circuitry 335 is instantiated by programmable circuitry executing query head group evaluation instructions and/or configured to perform operations such as those represented by the flowchart(s) of FIG. 5.

In some examples, the model execution circuitry 300 includes means for evaluating a group. For example, the means for evaluating may be implemented by query head group evaluation circuitry 335. In some examples, the query head group evaluation circuitry 335 may be instantiated by programmable circuitry such as the example programmable circuitry 1112 of FIG. 11. For instance, the query head group evaluation circuitry 335 may be instantiated by the example microprocessor 1200 of FIG. 12 executing machine executable instructions such as those implemented by at least blocks 520, 530, 532, 535, 540 of FIG. 5. In some examples, the query head group evaluation circuitry 335 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the query head group evaluation circuitry 335 may be instantiated by any other combination of hardware, software, and/or firmware. For example, the query head group evaluation circuitry 335 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the model execution circuitry 300 of FIG. 1 is illustrated in FIG. 3, one or more of the elements, processes, and/or devices illustrated in FIG. 3 may be combined, divided, re-arranged, omitted, eliminated, and/or implemented in any other way. Further, the model processing circuitry 305, the example query head grouping circuitry 330, the example query head group evaluation circuitry 335, and/or, more generally, the example model execution circuitry 300 of FIG. 3, may be implemented by hardware alone or by hardware in combination with software and/or firmware. Thus, for example, any of the model processing circuitry 305, the example query head grouping circuitry 330, the example query head group evaluation circuitry 335, and/or, more generally, the example model execution circuitry 300, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example model execution circuitry 300 of FIG. 3 may include one or more elements, processes, and/or devices in addition to, or instead of, those illustrated in FIG. 3, and/or may include more than one of any or all of the illustrated elements, processes and devices.

Flowchart(s) representative of example machine readable instructions, which may be executed by programmable circuitry to implement and/or instantiate the model execution circuitry 300 of FIG. 3 and/or representative of example operations which may be performed by programmable circuitry to implement and/or instantiate the model execution circuitry 300 of FIG. 3, are shown in FIGS. 4 and/or 5. The machine readable instructions may be one or more executable programs or portion(s) of one or more executable programs for execution by programmable circuitry such as the programmable circuitry 1112 shown in the example processor platform 1100 discussed below in connection with FIG. 11 and/or may be one or more function(s) or portion(s) of functions to be performed by the example programmable circuitry (e.g., an FPGA) discussed below in connection with FIGS. 12 and/or 13. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 4 and/or 5, many other methods of implementing the example model execution circuitry 300 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 4 and/or 5 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 4 is a flowchart representative of example machine readable instructions and/or example operations 400 that may be executed, instantiated, and/or performed by programmable circuitry to execute a machine learning model based on a KV-cache. The example machine-readable instructions and/or the example operations 400 of FIG. 4 begin at block 410, at which the model processing circuitry 305 accesses the KV cache 321 for execution of a model. (Block 410). The example model processing circuitry 305 executes the model using the information stored in the KV cache. (Block 420). As a result, a new token to be added to (e.g., appended to) the KV cache will be created. The example model processing circuitry 305 updates the KV cache based on the execution of the model. (Block 430).

The example query head grouping circuitry 330 determines whether to attempt to reduce the KV cache. (Block 440). In some examples, reduction of the KV cache might only be attempted periodically (e.g., after a threshold number of tokens have been generated since a prior reduction attempt) and/or a-periodically (e.g., once the KV cache has reached a threshold size), etc. If reduction is to be attempted, the example query head grouping circuitry 330 attempts to perform the reduction of the KV cache. (Block 445). An example approach to attempting to reduce the KV cache is described further below in connection with FIG. 5.

After reduction of the KV cache (e.g., block 445) or after a determination that an attempt to reduce the KV cache need not be performed (e.g., block 440 returns a result of NO), the example model processing circuitry 305 determines whether to continue execution. (Block 450). In some examples, the most recent output token includes a stop token, which indicates that the generation of the requested output is complete. The presence of such a stop token is used to determine whether to continue execution. If the next token does not include the stop token (e.g., block 450 returns a result of YES), the example process continues to block 410 where additional iterations of the process of blocks 410 through 445 are performed until a stop token is reached. If the example next token includes the stop token (e.g., block 450 returns a result of NO), the example model processing circuitry 305 provides the output of the execution of the machine learning model. (Block 460).

In some examples, the determination of whether to attempt to reduce the KV cache and subsequent attempt to reduce the KV cache (e.g., blocks 440 and 445) may be performed after a determination that operation is to be continued (e.g., after block 450 returns a result of YES, rather than prior to execution of block 450). Moreover, in some examples, conditions other than the presence of a stop token may be used to determine whether to end execution of the machine learning model. Moreover, in some examples, outputs may be provided while the execution of the machine learning model is in progress.

After the output of the result of the execution of the machine learning model is provided, the example process 400 of FIG. 4 is terminated. However, the example process 400 of FIG. 4 may be re-executed to, for example, process a subsequent prompt.

In the illustrated example of FIG. 4, the triggering of the reduction of the KV cache is illustrated as being performed during runtime of the transformer model (e.g., in an online manner). However, the reduction of the KV cache may additionally or alternatively be performed at other times (e.g., in an offline manner). For example, the reduction of the KV cache may be performed separately from generation of a response to a prompt. In this manner, the reduction of the KV cache may be performed while the model execution circuitry 300 awaits a subsequent prompt. As another example, the reduction of the KV cache may be performed in response to resource utilization exceeding a threshold (e.g., the KV cache meets or exceeds a threshold amount of memory).

FIG. 5 is a flowchart representative of example machine readable instructions and/or example operations 500 that may be executed, instantiated, and/or performed by programmable circuitry to perform reduction of a KV cache. The example machine-readable instructions and/or the example operations 500 of FIG. 5 begin at block 510, at which the query head grouping circuitry 330 attempts to form proposed groups of query heads for each layer in the KV-cache. However, while such proposed groups of query heads reduce KV-cache utilization, some of the proposed groups of query heads might adversely impact accuracy of the model. To handle the between KV-cache size and LLM accuracy, the example query head group evaluation circuitry 335 evaluates the impact of the proposed group on accuracy of the model (Block 520), and if the grouped head does not result in an accuracy threshold being met (Block 530), the head is retained in its non-grouped format (Block 532). If the accuracy threshold is met, the proposed grouping is used (Block 535), and subsequent proposed groups are evaluated if such groups exist (Block 540).

In this manner, examples disclosed herein allow for a fully flexible grouping of query heads in terms of the size of the group and selecting heads in the groups. Beyond forming arbitrary-sized groups, examples disclosed herein may constrain input representation to form equal-sized groups. Moreover, to eliminate the need for expensive GPU-based LLM accuracy (or perplexity), some examples systems, methods, and apparatus implementing QCQA utilize a computationally inexpensive fitness function, weight-sharing error (WSE), for candidate evaluations in a non-dominated sorting genetic search (NSGA-II) algorithm.

Returning to block 510, grouping of query heads may be accomplished in two different ways. As a first approach, KV heads may be grouped based on significance score clustering. Alternatively, an evolutionary algorithm may be utilized to form groups of query heads. In practice, the evolutionary algorithm approach might be selected for use on more performant computing systems such as servers, cloud computing infrastructures, and high-end workstations. In contrast, significance score clustering might be used on less performant computing systems such as mobile devices, laptops, tablets, etc.

Focusing first on significance score clustering, query heads may be grouped based on KV head significance score groups. In this manner, query heads having similar significance and/or importance score and a mean-pool corresponding Key and Value heads may be grouped. In other words, mean-pooling Key/Value heads that have very different distributions might diminish the quality of text generation. Unlike GQA, Key/Value heads with similar significance/importance scores are less impacted by mean-pooling since their mean and variance are similar. Moreover, clustering algorithms with a prespecified number of clusters (or groups) can be leveraged to form groups of query heads based on the significance score. In short, the example query head grouping circuitry 330 estimates significance scores for Key/Value heads, and then executes a clustering algorithm (e.g., K-means clustering) to get groups of query heads. As a result, groups of query heads are identified.

As an alternative to (and/or in combination with) the significance score clustering, the example query head grouping circuitry 330 may implement an evolutionary search algorithm that proposes grouped query heads. In examples disclosed herein, the evolutionary search algorithm operates on at least two objectives. A first objective is an estimation of an impact on the KV-cache, and a second objective is an estimation of the resultant quality of the output of the model.

The first objective function (O₁) is implemented using a product of all of the dimensions of the key or value feature dimensions including, for example, mini-batch size (B), input sequence length (T), a number of heads (H), and a hidden dimension of a head (d). In this manner, the first objective function may be calculated using Equation 1, below:

$${O}_{1} = B \times T \times H \times d \qquad Equation 1$$

The second objective function evaluated by the example query head grouping circuitry 330 estimates a quality of text that will be generated by the model. Equation 2, below, represents the objective function 2 (for quality of text generated by LLM) can be of the following form:

$$distortion score ( {O}_{2} ) = {\sum }_{j = 1 : G} {\sum }_{∀ i ∈ j} Frobenius\_norm ( {W}_{K , i}^{MHA} - {W}_{K , j}^{QCQA} ) + Frobenius\_norm ( {W}_{V , i}^{MHA} - {W}_{V , G}^{QCQA} ) \qquad Equation 2$$

In Equation 2, above, G is the number of groups and W_{K,i}^{MHA} is the i^{th} head weight matrix corresponding to the Key feature from MHA variant of the model. W_{K,j}^{QCQA} (=mean_pool(W_{K,i}^{MHA})|_{∀iϵj}) is the j^{th} head weight matrix corresponding to the mean-pooled Key feature from QCQA variant of the model. Similarly, W_{V,i}^{MHA} and W_{V,G}^{QCQA} are defined for value feature.

Grouped attention techniques introduce errors in attention layers as multiple query heads interact with a single merged key and value head. Systems, methods and apparatus disclosed herein utilize a weight sharing error (WSE) to indicate the LLM accuracy drop due to the error introduced by the grouping of query heads. For a given layer in LLM with H heads, MHA attention computation Aᵢ for i^{th} head with query (Qᵢ), key (Kᵢ), and value (Vᵢ) features of d dimension is given by Equation 3, below:

$${A}_{i} = softmax ( \frac{{Q}_{i} {K}_{i}^{T}}{\sqrt{d}} ) {V}_{i} \qquad Equation 3$$

Let K_{G} and V_{G} denote a merged key and value feature heads, respectively, for the j^{th} group Gⱼ, then the grouped attention for i^{th} query head Âᵢ that belongs to Gⱼ group is given by Equation 4, below:

$${\hat{A}}_{i} = softmax ( \frac{{Q}_{i} {K}_{{G}_{j}}^{T}}{\sqrt{d}} ) {V}_{{G}_{j}} \qquad Equation 4$$

The difference between the distributions of Aᵢ and Âᵢ leads to accuracy loss in LLMs and by minimizing it accuracy drop for grouped attention techniques can be improved significantly. Instead of estimating the distance between two attention distributions, the accuracy drop can be computed more economically by using key and value head distributions, as given by equation (5), below:

$$\hat{L} = {\sum }_{j = 1 : P} {\sum }_{i ∈ {G}_{j}} [ E [ {( {K}_{i} - {K}_{{G}_{j}} )}^{2} ] + E [ {( {V}_{i} - {V}_{{G}_{j}} )}^{2} ] ] \qquad Equation 5$$

where P is the number of groups. Since the only source of error is the merging of key and value weight matrices, a simple and inexpensive alternative formulation is, equation (6), below:

$$L = {\sum }_{j = 1 : P} {\sum }_{i ∈ {G}_{j}} [ E [ {( {W}_{{K}_{i}} - {W}_{{K}_{{G}_{j}}} )}^{2} ] + E [ {( {W}_{{V}_{i}} - {W}_{{V}_{{G}_{j}}} )}^{2} ] ] \qquad Equation 6$$

where W_{K}_{ᵢ} and W_{V}_{ᵢ} are weight matrices of i^{th} key and value head, respectively. Similarly,

$${W}_{{K}_{{G}_{j}}} and {W}_{{V}_{{G}_{j}}}$$

are mean-pooled key and value head weights belonging to Gⱼ^{th} group, respectively. The formulation in equation (4) is simple and does not depend on input data or actual numerical values of key and value features. This formulation bears a precise resemblance to the sum of squared errors (SSE) used in the K-means algorithm. Since the mean-pooled head WKGj or WVGj are shared with corresponding query heads in the group, the formulation in equation 6 is referred to herein as the weight-sharing error (WSE). The evaluation shows a strong relationship between accuracy drop and WSE. Hence, WSE can be reliably used as an alternative to expensive LLM accuracy estimation.

When proposing groups of query heads using the evolutionary algorithm, groups of query heads may be proposed of equal size (e.g., equal cardinality) or of different size (e.g., arbitrary cardinality). In an arbitrary cardinality implementation, the example query head grouping circuitry 330 seeks to form arbitrary-sized groups of query heads by arranging as many heads as possible in a group while keeping accuracy impact minimal. As a result, this variant offers additional flexibility in forming groups. For H number of heads and at most P groups, the following candidate representation is adopted:

$$X {\{ 0 , 1 , … , P - 1 \}}^{H} \qquad Equation 7$$

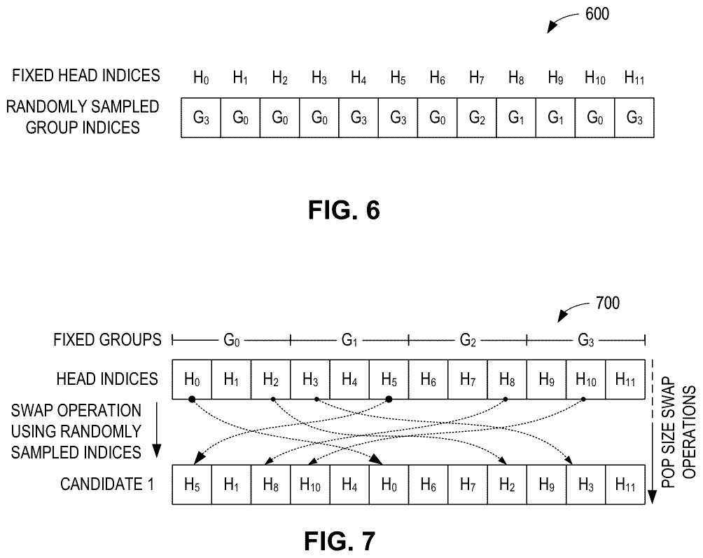

In this representation, each i^{th} element of X is the i^{th} head belonging to the group X[i] as illustrated in FIG. 6. FIG. 6 is a diagram illustrating assignment of query heads 600 to various groups using an arbitrary cardinality implementation. All such possible values of X will yield a valid and robust input representation for which computation of KV-cache memory requirement and proxy metric is tractable. The initial pool of candidates X will start with randomly formed groups where each group index is uniformly sampled.

FIG. 7 is a diagram illustrating assignment of query heads 700 to various groups using an equal cardinality implementation. In an equal cardinality implementation, the example query head grouping circuitry 330 enforces a constraint on the exact number of heads in a group, as shown in FIG. 7. The equal cardinality constraint is enforced as follows:

$$X {\{ 0 , 1 , … , H - 1 \}}^{H} \qquad Equation 8$$

Unlike the arbitrary cardinality implementation, the equal cardinality implementation utilizes unique elements in its representation X because each entry indicates an index of a head out of H heads. As a result, randomly sampling the population of candidates X, crossover, and mutation operations will not always result in a valid representation because such an approach might lead to duplicate elements in X. To address this, X is initialized as X=[0, 1, . . . , H-1] and a population of a pair of two head indices is randomly sampled to be swapped in X. For example, randomly select i^{th} and j^{th} groups to perform a swap operation. Let SP₁˜U([0, 1, . . . , P-1]) and SP₂˜U([0,1, . . . , P-1]) be two uniformly sampled indices. A candidate for the initial random population can be obtained by the swap (X, SP₁, SP₂) operation. As a result, the population of swap pairs will produce a valid population of X candidates for EA with different possible group arrangements but all groups will have equal cardinality. As a result of the crossover/swapping of head indices within each group, query heads that were initially adjacent to each other (e.g., H0 is adjacent to H1, which is adjacent to H2, etc.), will likely end up not being adjacent to each other. In this manner, the examples disclosed herein are distinguished from a GQA approach, in which adjacent query heads are simply grouped together, without respect to the value of those heads or the impact of this grouping on accuracy of the model.

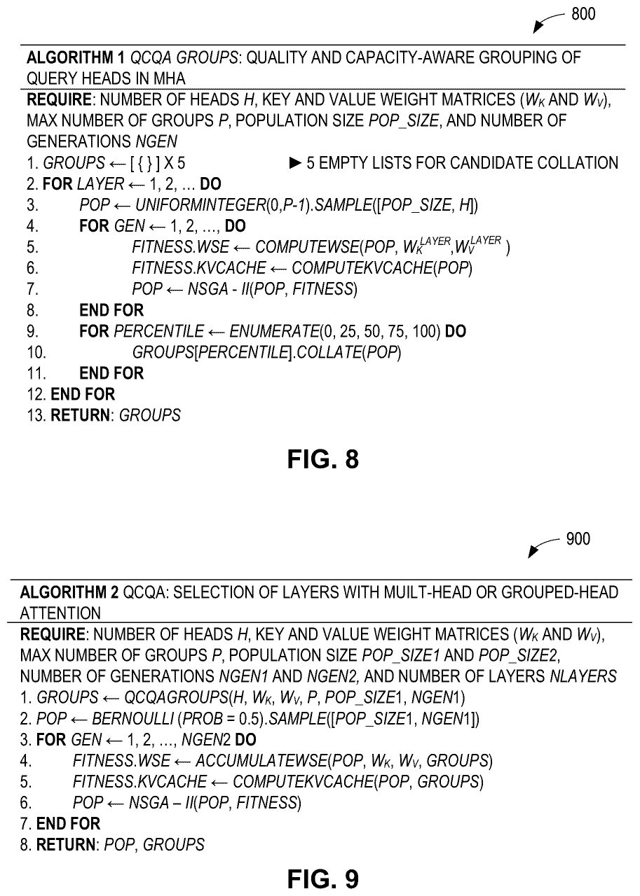

FIG. 8 is an example algorithm 800 that may be used to implement grouping of query heads using an evolutionary algorithm (EA) approach. Such an algorithm is implemented at block 510 of FIG. 5. The algorithm 800 of FIG. 8 takes as input, key and value weight matrices and assumes P groups to be formed at most. The groups are formed for each layer individually by leveraging the WSE and KV-cache as fitness functions (e.g., see lines 5 and 6 of FIG. 8). This approach results in improved accuracy as compared to forming groups using a combined representation of all layers. Line 3 in the algorithm 800 of FIG. 8 implements QCQA-AC (i.e., an arbitrary cardinality implementation), however, in some examples, line 3 may be replaced with the corresponding formulation for QCQA-EQ (an equal cardinality implementation) as discussed above. A ComputeWSE function at line 5 of FIG. 8 computes the weight sharing error (see equation 4) for a layer according to the grouping information in each sample of the population. Similarly, a ComputeKVcache function, at line 6 of FIG. 8, estimates the KV-cache size of a given grouping.

Within a generation, the NSGA-II algorithm operates on a given population and computed fitness functions to return next-generation candidates. Each layer forms different suitable candidates which must be collated together to get wider and/or granular variation in KV-cache and WSE. For example, two candidates are collated if they belong to the same out of five different percentiles.

An input Iₛ for the NSGA-II algorithm is a binary array of shape [H, H]:

$${I}_{s} = {\{ 0 , 1 \}}^{H , H} \qquad Equation 9$$

Iₛ is initialized as an array of zeros. The number of Query head groups is determined by the number of non-zero rows in the array Iₛ. When j^{th} Query head (Qⱼ) belongs to i^{th} (Gᵢ) group, 1 is filled at j^{th} column index of i^{th} row in the Iₛ, represented by Equation 10, below.

$${{I}_{s} [ i , j ] = 1 \vert}_{{Q}_{j} ∈ {G}_{i}} \qquad Equation 10$$

Returning to FIG. 5, after the formation of the proposed groups (Block 510), those groups are evaluated by the query head group evaluation circuitry 335 to determine whether a predicted accuracy of the group meets an accuracy threshold. (Block 520). The second stage evaluates the impact of applying grouping to a layer on the LLM accuracy. Layers with a high impact on LLM accuracy are retained in their original MHA implementation (Block 532), otherwise the query heads are grouped to minimize KV-cache (Block 535). Each proposed grouping is considered (Block 540) by the example query head group evaluation circuitry 335, and groupings are retained or modified, as appropriate.

In examples disclosed herein, the evaluation of the expected accuracy of the grouping utilizes a weight sharing error (WSE) evaluation and a KV-cache size estimation for calculating the fitness of candidates. An example approach to evaluating the accuracy of the proposed groups is described in further detail in FIG. 9. FIG. 9 represents an approach 900 for selecting layers to preserve the grouping information. Other layers are retained in the MHA implementation by not forming groups. After obtaining optimal groups from algorithm 1 (line 1 of FIG. 9) an initial population is sampled by sampling an array with a binary random variable with equally likely states (line 2 of FIG. 9). The i^{th} entry of 1 in a candidate of the population indicates that the grouping is preserved for the i^{th} layer otherwise the layer is retained in the MHA implementation. For example, the AccumulateWSE function (line 4 of FIG. 9) computes and accumulates WSE across all the selected layers given by a candidate in the population.

The example approaches disclosed herein were evaluated on multiple LLM models, tasks, and datasets. From a given pretrained MHA model, QCQA and GQA models were derived with different KV-cache sizes. The reported KV-cache sizes are normalized with that of the MHA model. For each of these models, LLM task accuracy (average of Hellaswag, ARC-easy, and challenge benchmarks) is evaluated at different KV-cache sizes before and after fine-tuning. An alpaca-cleaned dataset was used for fine-tuning. Further details on the models, datasets, experiments, hyperparameters, and evaluation setup are provided below.

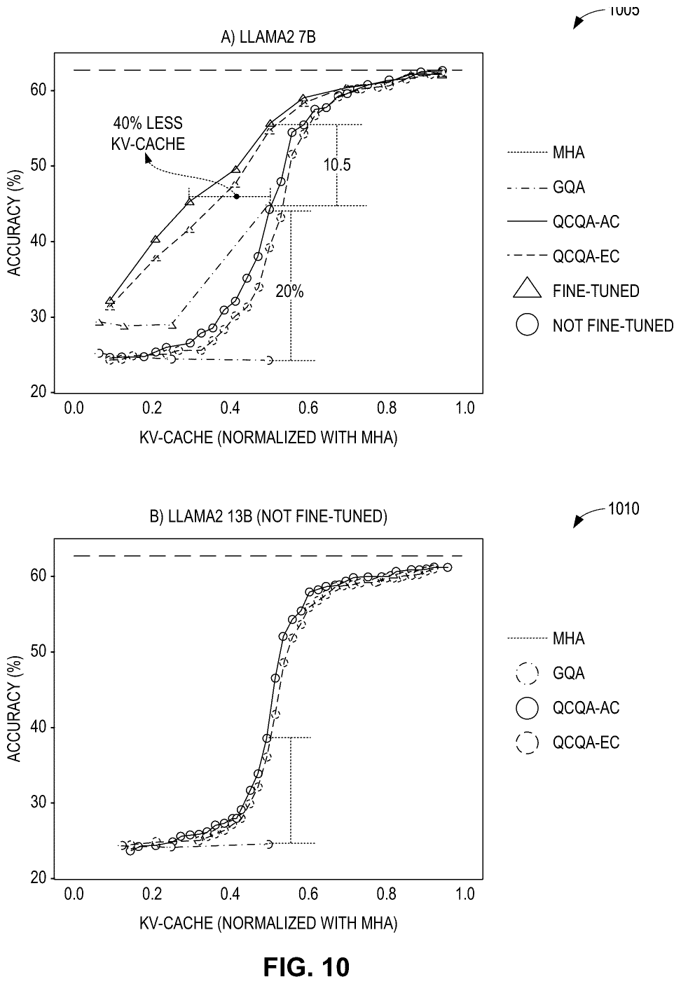

FIG. 10 illustrates task accuracy achieved using the example approaches disclosed herein across varying sizes of a KV-cache. A first graph 1005 illustrates accuracy (as compared to an MHA implementation) versus a size of a KV-cache for a seven billion parameter model (e.g., Llama2 7B). A second graph 1010 illustrates accuracy (as compared to an MHA implementation) versus a size of a KV-cache for a thirteen billion parameter model (e.g., Llama2 13B). As is illustrated in the first and second graphs 1005, 1010, GQA allows for only a few discrete sizes of query groups. In contrast, the example approaches disclosed herein (e.g., QCQA) offers finer granularity of KV-cache sizes due to the flexibility in choosing an arbitrary number of heads per group as well as the number of layers for grouping. Such flexibility can enable the LLM model optimization for any memory budget.

As is shown in the first and second graphs, for the KV-cache size of 0.5, GQA accuracy drops to 24.3% for Llama2 7B and 24.7% for Llama2 13B. Example approaches disclosed herein implemented using an arbitrary cardinality approach achieve 44.3% accuracy for Llama2 7B and 38.6% for Llama2 13B. For both Llama2 model sizes, GQA loses significant accuracy and does not show any improvement in accuracy with increasing KV-cache size. However, the examples disclosed herein (utilizing either an arbitrary cardinality or equal cardinality approach) shows an excellent tradeoff between KV-cache size and average accuracy. QCQA provides steep accuracy gains for the KV-cache sizes in the interval of [0.3, 0.7]. In the same interval, QCQA-AC outperforms QCQA-EC for both Llama2 model sizes. This demonstrates the efficacy of arbitrary-sized grouping of query heads over that of equal-sized.

With respect to a fine-tuned model as is illustrated in the first graph 1005 of FIG. 10, QCQA (both AC and EC) consistently outperforms GQA for all KV-cache sizes. At 0.5 KV-cache size, QCQA-AC achieves 55.56% which is 10.55% higher than GQA (45.01%). As evident from the accuracy trend of QCQA-AC and QCQA-EC, arbitrary cardinality provides noticeable accuracy improvements over equal cardinality below 0.7 KV-cache size. Unlike GQA, QCQA-AC (and EC) both gain in accuracy by a large margin after fine-tuning for lower KV-cache sizes. This allows QCQA-AC to achieve the same accuracy as that of GQA for 40% lesser KV-cache size. Compared to MHA, QCQA-AC (and EC) achieve almost 20% savings in KV-cache with a minor drop (≈2%) in average accuracy.

Interestingly, at 0.5 KV-cache size, a non-fine-tuned QCQA-AC model (represented in the second graph 1010 of FIG. 10) achieves the same accuracy as that of GQA fine-tuned for 3 epochs. The benefits of quality and capacity-aware grouping of query heads are clearly visible across different KV-cache sizes. QCQA-EC archives 14% higher accuracy than GQA for the same KV-cache size. This shows the effectiveness of the examples disclosed herein, even for equal-sized groups. Accuracy improvement by using query groups of arbitrary cardinality can be significant particularly when fine-tuning is not availed. QCQA-AC provides up to 4-8% higher accuracy than QCQA-EC for KV-cache sizes in the mid-range interval [0.3, 0.7].

FIG. 11 is a block diagram of an example programmable circuitry platform 1100 structured to execute and/or instantiate the example machine-readable instructions and/or the example operations of FIGS. 4 and/or 5 to implement the model execution circuitry 300 of FIG. 3. The programmable circuitry platform 1100 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1100 of the illustrated example includes programmable circuitry 1112. The programmable circuitry 1112 of the illustrated example is hardware. For example, the programmable circuitry 1112 can be implemented by one or more integrated circuits, logic circuits, FPGAs, microprocessors, CPUs, GPUs, DSPs, and/or microcontrollers from any desired family or manufacturer. The programmable circuitry 1112 may be implemented by one or more semiconductor based (e.g., silicon based) devices. In this example, the programmable circuitry 1112 implements the model processing circuitry 305, the query head grouping circuitry query head group evaluation circuitry 335.

The programmable circuitry 1112 of the illustrated example includes a local memory 1113 (e.g., a cache, registers, etc.). The programmable circuitry 1112 of the illustrated example is in communication with main memory 1114, 1116, which includes a volatile memory 1114 and a non-volatile memory 1116, by a bus 1118. The volatile memory 1114 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1116 may be implemented by flash memory and/or any other desired type of memory device. Access to the main memory 1114, 1116 of the illustrated example is controlled by a memory controller 1117. In some examples, the memory controller 1117 may be implemented by one or more integrated circuits, logic circuits, microcontrollers from any desired family or manufacturer, or any other type of circuitry to manage the flow of data going to and from the main memory 1114, 1116.

The programmable circuitry platform 1100 of the illustrated example also includes interface circuitry 1120. The interface circuitry 1120 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1122 are connected to the interface circuitry 1120. The input device(s) 1122 permit(s) a user (e.g., a human user, a machine user, etc.) to enter data and/or commands into the programmable circuitry 1112. The input device(s) 1122 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1124 are also connected to the interface circuitry 1120 of the illustrated example. The output device(s) 1124 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1120 of the illustrated example, thus, typically includes a graphics driver card, a graphics driver chip, and/or graphics processor circuitry such as a GPU.

The interface circuitry 1120 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1126. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1100 of the illustrated example also includes one or more mass storage discs or devices 1128 to store firmware, software, and/or data. Examples of such mass storage discs or devices 1128 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 1132, which may be implemented by the machine readable instructions of FIGS. 4 and/or 5, may be stored in the mass storage device 1128, in the volatile memory 1114, in the non-volatile memory 1116, and/or on at least one non-transitory computer readable storage medium such as a CD or DVD which may be removable.

FIG. 12 is a block diagram of an example implementation of the programmable circuitry 1112 of FIG. 11. In this example, the programmable circuitry 1112 of FIG. 11 is implemented by a microprocessor 1200. For example, the microprocessor 1200 may be a general-purpose microprocessor (e.g., general-purpose microprocessor circuitry). The microprocessor 1200 executes some or all of the machine-readable instructions of the flowcharts of FIGS. 4 and/or 5 to effectively instantiate the circuitry of FIG. 2 as logic circuits to perform operations corresponding to those machine readable instructions. In some such examples, the circuitry of FIG. 3 is instantiated by the hardware circuits of the microprocessor 1200 in combination with the machine-readable instructions. For example, the microprocessor 1200 may be implemented by multi-core hardware circuitry such as a CPU, a DSP, a GPU, an XPU, etc. Although it may include any number of example cores 1202 (e.g., 1 core), the microprocessor 1200 of this example is a multi-core semiconductor device including N cores. The cores 1202 of the microprocessor 1200 may operate independently or may cooperate to execute machine readable instructions. For example, machine code corresponding to a firmware program, an embedded software program, or a software program may be executed by one of the cores 1202 or may be executed by multiple ones of the cores 1202 at the same or different times. In some examples, the machine code corresponding to the firmware program, the embedded software program, or the software program is split into threads and executed in parallel by two or more of the cores 1202. The software program may correspond to a portion or all of the machine readable instructions and/or operations represented by the flowcharts of FIGS. 4 and/or 5.

The cores 1202 may communicate by a first example bus 1204. In some examples, the first bus 1204 may be implemented by a communication bus to effectuate communication associated with one(s) of the cores 1202. For example, the first bus 1204 may be implemented by at least one of an Inter-Integrated Circuit (I2C) bus, a Serial Peripheral Interface (SPI) bus, a PCI bus, or a PCIe bus. Additionally or alternatively, the first bus 1204 may be implemented by any other type of computing or electrical bus. The cores 1202 may obtain data, instructions, and/or signals from one or more external devices by example interface circuitry 1206. The cores 1202 may output data, instructions, and/or signals to the one or more external devices by the interface circuitry 1206. Although the cores 1202 of this example include example local memory 1220 (e.g., Level 1 (L1) cache that may be split into an L1 data cache and an L1 instruction cache), the microprocessor 1200 also includes example shared memory 1210 that may be shared by the cores (e.g., Level 2 (L2 cache)) for high-speed access to data and/or instructions. Data and/or instructions may be transferred (e.g., shared) by writing to and/or reading from the shared memory 1210. The local memory 1220 of each of the cores 1202 and the shared memory 1210 may be part of a hierarchy of storage devices including multiple levels of cache memory and the main memory (e.g., the main memory 1114, 1116 of FIG. 11). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1202 may be referred to as a CPU, DSP, GPU, etc., or any other type of hardware circuitry. Each core 1202 includes control unit circuitry 1214, arithmetic and logic (AL) circuitry (sometimes referred to as an ALU) 1216, a plurality of registers 1218, the local memory 1220, and a second example bus 1222. Other structures may be present. For example, each core 1202 may include vector unit circuitry, single instruction multiple data (SIMD) unit circuitry, load/store unit (LSU) circuitry, branch/jump unit circuitry, floating-point unit (FPU) circuitry, etc. The control unit circuitry 1214 includes semiconductor-based circuits structured to control (e.g., coordinate) data movement within the corresponding core 1202. The AL circuitry 1216 includes semiconductor-based circuits structured to perform one or more mathematic and/or logic operations on the data within the corresponding core 1202. The AL circuitry 1216 of some examples performs integer based operations. In other examples, the AL circuitry 1216 also performs floating-point operations. In yet other examples, the AL circuitry 1216 may include first AL circuitry that performs integer-based operations and second AL circuitry that performs floating-point operations. In some examples, the AL circuitry 1216 may be referred to as an Arithmetic Logic Unit (ALU).

The registers 1218 are semiconductor-based structures to store data and/or instructions such as results of one or more of the operations performed by the AL circuitry 1216 of the corresponding core 1202. For example, the registers 1218 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1218 may be arranged in a bank as shown in FIG. 12. Alternatively, the registers 1218 may be organized in any other arrangement, format, or structure, such as by being distributed throughout the core 1202 to shorten access time. The second bus 1222 may be implemented by at least one of an I2C bus, a SPI bus, a PCI bus, or a PCIe bus.

Each core 1202 and/or, more generally, the microprocessor 1200 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1200 is a semiconductor device fabricated to include many transistors interconnected to implement the structures described above in one or more integrated circuits (ICs) contained in one or more packages.

The microprocessor 1200 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1200, in the same chip package as the microprocessor 1200 and/or in one or more separate packages from the microprocessor 1200.

FIG. 13 is a block diagram of another example implementation of the programmable circuitry 1112 of FIG. 11. In this example, the programmable circuitry 1112 is implemented by FPGA circuitry 1300. For example, the FPGA circuitry 1300 may be implemented by an FPGA. The FPGA circuitry 1300 can be used, for example, to perform operations that could otherwise be performed by the example microprocessor 1200 of FIG. 12 executing corresponding machine readable instructions. However, once configured, the FPGA circuitry 1300 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1200 of FIG. 12 described above (which is a general purpose device that may be programmed to execute some or all of the machine readable instructions represented by the flowchart(s) of FIGS. 4 and/or 5 but whose interconnections and logic circuitry are fixed once fabricated), the FPGA circuitry 1300 of the example of FIG. 13 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 4 and/or 5. In particular, the FPGA circuitry 1300 may be thought of as an array of logic gates, interconnections, and switches. The switches can be programmed to change how the logic gates are interconnected by the interconnections, effectively forming one or more dedicated logic circuits (unless and until the FPGA circuitry 1300 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 4 and/or 5. As such, the FPGA circuitry 1300 may be configured and/or structured to effectively instantiate some or all of the operations/functions corresponding to the machine readable instructions of the flowchart(s) of FIGS. 4 and/or 5 as dedicated logic circuits to perform the operations/functions corresponding to those software instructions in a dedicated manner analogous to an ASIC. Therefore, the FPGA circuitry 1300 may perform the operations/functions corresponding to the some or all of the machine readable instructions of FIGS. 4 and/or 5 faster than the general-purpose microprocessor can execute the same.

In the example of FIG. 13, the FPGA circuitry 1300 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1300 of FIG. 13 may access and/or load the binary file to cause the FPGA circuitry 1300 of FIG. 13 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1300 of FIG. 13 to cause configuration and/or structuring of the FPGA circuitry 1300 of FIG. 13, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1300 of FIG. 13 may access and/or load the binary file to cause the FPGA circuitry 1300 of FIG. 13 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1300 of FIG. 13 to cause configuration and/or structuring of the FPGA circuitry 1300 of FIG. 13, or portion(s) thereof.

The FPGA circuitry 1300 of FIG. 13, includes example input/output (I/O) circuitry 1302 to obtain and/or output data to/from example configuration circuitry 1304 and/or external hardware 1306. For example, the configuration circuitry 1304 may be implemented by interface circuitry that may obtain a binary file, which may be implemented by a bit stream, data, and/or machine-readable instructions, to configure the FPGA circuitry 1300, or portion(s) thereof. In some such examples, the configuration circuitry 1304 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1306 may be implemented by external hardware circuitry. For example, the external hardware 1306 may be implemented by the microprocessor 1200 of FIG. 12.

The FPGA circuitry 1300 also includes an array of example logic gate circuitry 1308, a plurality of example configurable interconnections 1310, and example storage circuitry 1312. The logic gate circuitry 1308 and the configurable interconnections 1310 are configurable to instantiate one or more operations/functions that may correspond to at least some of the machine readable instructions of FIGS. 4 and/or 5 and/or other desired operations. The logic gate circuitry 1308 shown in FIG. 13 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1308 to enable configuration of the electrical structures and/or the logic gates to form circuits to perform desired operations/functions. The logic gate circuitry 1308 may include other electrical structures such as look-up tables (LUTs), registers (e.g., flip-flops or latches), multiplexers, etc.

The configurable interconnections 1310 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1308 to program desired logic circuits.

The storage circuitry 1312 of the illustrated example is structured to store result(s) of the one or more of the operations performed by corresponding logic gates. The storage circuitry 1312 may be implemented by registers or the like. In the illustrated example, the storage circuitry 1312 is distributed amongst the logic gate circuitry 1308 to facilitate access and increase execution speed.

The example FPGA circuitry 1300 of FIG. 13 also includes example dedicated operations circuitry 1314. In this example, the dedicated operations circuitry 1314 includes special purpose circuitry 1316 that may be invoked to implement commonly used functions to avoid the need to program those functions in the field. Examples of such special purpose circuitry 1316 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1300 may also include example general purpose programmable circuitry 1318 such as an example CPU 1320 and/or an example DSP 1322. Other general purpose programmable circuitry 1318 may additionally or alternatively be present such as a GPU, an XPU, etc., that can be programmed to perform other operations.

Although FIGS. 12 and 13 illustrate two example implementations of the programmable circuitry 1112 of FIG. 11, many other approaches are contemplated. For example, FPGA circuitry may include an on-board CPU, such as one or more of the example CPU 1320 of FIG. 12. Therefore, the programmable circuitry 1112 of FIG. 11 may additionally be implemented by combining at least the example microprocessor 1200 of FIG. 12 and the example FPGA circuitry 1300 of FIG. 13. In some such hybrid examples, one or more cores 1202 of FIG. 12 may execute a first portion of the machine readable instructions represented by the flowchart(s) of FIGS. 4 and/or 5 to perform first operation(s)/function(s), the FPGA circuitry 1300 of FIG. 13 may be configured and/or structured to perform second operation(s)/function(s) corresponding to a second portion of the machine readable instructions represented by the flowcharts of FIG. 4 and/or 5, and/or an ASIC may be configured and/or structured to perform third operation(s)/function(s) corresponding to a third portion of the machine readable instructions represented by the flowcharts of FIGS. 4 and/or 5.

It should be understood that some or all of the circuitry of FIG. 3 may, thus, be instantiated at the same or different times. For example, same and/or different portion(s) of the microprocessor 1200 of FIG. 12 may be programmed to execute portion(s) of machine-readable instructions at the same and/or different times. In some examples, same and/or different portion(s) of the FPGA circuitry 1300 of FIG. 13 may be configured and/or structured to perform operations/functions corresponding to portion(s) of machine-readable instructions at the same and/or different times.

In some examples, some or all of the circuitry of FIG. 3 may be instantiated, for example, in one or more threads executing concurrently and/or in series. For example, the microprocessor 1200 of FIG. 12 may execute machine readable instructions in one or more threads executing concurrently and/or in series. In some examples, the FPGA circuitry 1300 of FIG. 13 may be configured and/or structured to carry out operations/functions concurrently and/or in series. Moreover, in some examples, some or all of the circuitry of FIG. 3 may be implemented within one or more virtual machines and/or containers executing on the microprocessor 1200 of FIG. 12.

In some examples, the programmable circuitry 1112 of FIG. 11 may be in one or more packages. For example, the microprocessor 1200 of FIG. 12 and/or the FPGA circuitry 1300 of FIG. 13 may be in one or more packages. In some examples, an XPU may be implemented by the programmable circuitry 1112 of FIG. 11, which may be in one or more packages. For example, the XPU may include a CPU (e.g., the microprocessor 1200 of FIG. 12, the CPU 1320 of FIG. 13, etc.) in one package, a DSP (e.g., the DSP 1322 of FIG. 13) in another package, a GPU in yet another package, and an FPGA (e.g., the FPGA circuitry 1300 of FIG. 13) in still yet another package.

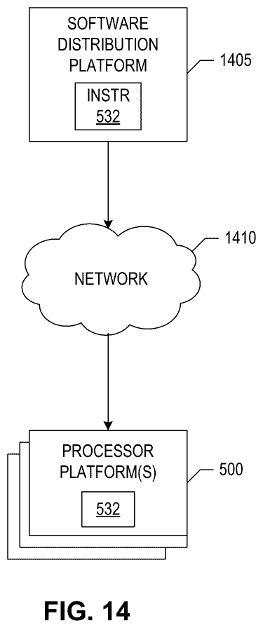

A block diagram illustrating an example software distribution platform 1405 to distribute software such as the example machine readable instructions 1132 of FIG. 11 to other hardware devices (e.g., hardware devices owned and/or operated by third parties from the owner and/or operator of the software distribution platform) is illustrated in FIG. 14. The example software distribution platform 1405 may be implemented by any computer server, data facility, cloud service, etc., capable of storing and transmitting software to other computing devices. The third parties may be customers of the entity owning and/or operating the software distribution platform 1405. For example, the entity that owns and/or operates the software distribution platform 1405 may be a developer, a seller, and/or a licensor of software such as the example machine readable instructions 1132 of FIG. 11. The third parties may be consumers, users, retailers, OEMs, etc., who purchase and/or license the software for use and/or re-sale and/or sub-licensing. In the illustrated example, the software distribution platform 1405 includes one or more servers and one or more storage devices. The storage devices store the machine readable instructions 1132, which may correspond to the example machine readable instructions of FIGS. 4 and/or 5, as described above. The one or more servers of the example software distribution platform 1405 are in communication with an example network 1410, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1132 from the software distribution platform 1405. For example, the software, which may correspond to the example machine readable instructions of FIG. 4 and/or 5, may be downloaded to the example programmable circuitry platform 1100, which is to execute the machine readable instructions 1132 to implement the model execution circuitry 300. In some examples, one or more servers of the software distribution platform 1405 periodically offer, transmit, and/or force updates to the software (e.g., the example machine readable instructions 1132 of FIG. 11) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that enable grouping of query heads in a key-value cache. Such approaches result in reduced sizes of KV-cache data used when executing a machine learning model, while maintaining accuracy. Disclosed systems, apparatus, articles of manufacture, and methods improve the efficiency of using a computing device by enabling smaller memory footprints for execution of machine learning models. In some examples, this smaller footprint enables the machine learning model(s) to be executed on hardware that would otherwise not be capable of executing such a model. Disclosed systems, apparatus, articles of manufacture, and methods are accordingly directed to one or more improvement(s) in the operation of a machine such as a computer or other electronic and/or mechanical device.

It is noted that this patent claims priority from India Patent Application Number 202441044447, which was filed on Jun. 8, 2024, and is hereby incorporated by reference in its entirety.

Example methods, apparatus, systems, and articles of manufacture for quality and capacity-aware grouped query attention are disclosed herein. Further examples and combinations thereof include the following:

Example 1 includes At least one non-transitory machine-readable medium comprising machine-readable instructions to cause at least one processor circuit to at least create a plurality of groups of query heads present in a key value cache using an evolutionary algorithm based on at least two objectives, quantify an amount of error introduced by a first group of query heads in the plurality of groups of query heads, and retain the query heads of the first group of query heads in a non-grouped arrangement when the error meets an error threshold.

Example 2 includes the at least one non-transitory machine-readable medium of example 1, wherein a first objective of the evolutionary algorithm is an estimated impact on a size of the key value cache.

Example 3 includes the at least one non-transitory machine-readable medium of example 2, wherein a second objective of the evolutionary algorithm is an estimation of a resultant quality of an output of a model.

Example 4 includes the at least one non-transitory machine-readable medium of any prior example, wherein the plurality of groups includes a first group of query heads having a first number of query heads and a second group of query heads having a second number of query heads different from the first number of query heads.

Example 5 includes the at least one non-transitory machine-readable medium of any prior example, wherein the plurality of groups includes a first group of query heads having a first number of query heads and a second group of query heads having the first number of query heads, the first group of query heads not grouped based on adjacency of neighboring query heads in the key value cache.

Example 6 includes the at least one non-transitory machine-readable medium of any prior example, wherein the non-grouped arrangement is a multi-head attention arrangement.

Example 7 includes the at least one non-transitory machine-readable medium of any prior example, wherein the amount of error is implemented by calculating a weight sharing error to indicate an expected drop in accuracy due to the error introduced by the grouping of query heads.

Example 8 includes an apparatus comprising interface circuitry, machine-readable instructions, and at least one processor circuit to be programmed by the machine-readable instructions to create a plurality of groups of query heads present in a key value cache using an evolutionary algorithm based on at least two objectives, quantify an amount of error introduced by a first group of query heads in the plurality of groups of query heads, and retain the query heads of the first group of query heads in a non-grouped arrangement when the error meets an error threshold.

Example 9 includes the apparatus of example 8, wherein a first objective of the evolutionary algorithm is an estimated impact on a size of the key value cache.

Example 10 includes the apparatus of example 9, wherein a second objective of the evolutionary algorithm is an estimation of a resultant quality of an output of a model.

Example 11 includes the apparatus of any prior example, wherein the plurality of groups includes a first group of query heads having a first number of query heads and a second group of query heads having a second number of query heads different from the first number of query heads.

Example 12 includes the apparatus of any prior example, wherein the plurality of groups includes a first group of query heads having a first number of query heads and a second group of query heads having the first number of query heads, the first group of query heads not grouped based on adjacency of neighboring query heads in the key value cache.

Example 13 includes the apparatus of any prior example, wherein the non-grouped arrangement is a multi-head attention arrangement.

Example 14 includes the apparatus of any prior example, wherein the amount of error is implemented by calculating a weight sharing error to indicate an expected drop in accuracy due to the error introduced by the grouping of query heads.

Example 15 includes a method for grouping of query heads in a key value cache, the method comprising creating a plurality of groups of query heads present in a key value cache using an evolutionary algorithm based on at least two objectives, quantifying an amount of error introduced by a first group of query heads in the plurality of groups of query heads, and retaining the query heads of the first group of query heads in a non-grouped arrangement when the error meets an error threshold.

Example 16 includes the method of example 15, wherein a first objective of the evolutionary algorithm is an estimated impact on a size of the key value cache.

Example 17 includes the method of example 16, wherein a second objective of the evolutionary algorithm is an estimation of a resultant quality of an output of a model.

Example 18 includes the method of any prior example, wherein the plurality of groups includes a first group of query heads having a first number of query heads and a second group of query heads having a second number of query heads different from the first number of query heads.

Example 19 includes the method of any prior example, wherein the plurality of groups includes a first group of query heads having a first number of query heads and a second group of query heads having the first number of query heads, the first group of query heads not grouped based on adjacency of neighboring query heads in the key value cache.

Example 20 includes the method of any prior example, wherein the non-grouped arrangement is a multi-head attention arrangement.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. At least one non-transitory machine-readable medium comprising machine-readable instructions to cause at least one processor circuit to at least:
create a plurality of groups of query heads present in a key value cache using an evolutionary algorithm based on at least two objectives;
quantify an amount of error introduced by a first group of query heads in the plurality of groups of query heads; and
retain the query heads of the first group of query heads in a non-grouped arrangement when the error meets an error threshold.

2. The at least one non-transitory machine-readable medium of claim 1, wherein a first objective of the evolutionary algorithm is an estimated impact on a size of the key value cache.

3. The at least one non-transitory machine-readable medium of claim 2, wherein a second objective of the evolutionary algorithm is an estimation of a resultant quality of an output of a model.

4. The at least one non-transitory machine-readable medium of claim 1, wherein the plurality of groups includes a first group of query heads having a first number of query heads and a second group of query heads having a second number of query heads different from the first number of query heads.

5. The at least one non-transitory machine-readable medium of claim 1, wherein the plurality of groups includes a first group of query heads having a first number of query heads and a second group of query heads having the first number of query heads, the first group of query heads not grouped based on adjacency of neighboring query heads in the key value cache.

6. The at least one non-transitory machine-readable medium of claim 1, wherein the non-grouped arrangement is a multi-head attention arrangement.

7. The at least one non-transitory machine-readable medium of claim 1, wherein the amount of error is implemented by calculating a weight sharing error to indicate an expected drop in accuracy due to the error introduced by the grouping of query heads.

8. An apparatus comprising:
interface circuitry;
machine-readable instructions; and
at least one processor circuit to be programmed by the machine-readable instructions to:
create a plurality of groups of query heads present in a key value cache using an evolutionary algorithm based on at least two objectives;
quantify an amount of error introduced by a first group of query heads in the plurality of groups of query heads; and
retain the query heads of the first group of query heads in a non-grouped arrangement when the error meets an error threshold.

9. The apparatus of claim 8, wherein a first objective of the evolutionary algorithm is an estimated impact on a size of the key value cache.

10. The apparatus of claim 9, wherein a second objective of the evolutionary algorithm is an estimation of a resultant quality of an output of a model.

11. The apparatus of claim 8, wherein the plurality of groups includes a first group of query heads having a first number of query heads and a second group of query heads having a second number of query heads different from the first number of query heads.

12. The apparatus of claim 8, wherein the plurality of groups includes a first group of query heads having a first number of query heads and a second group of query heads having the first number of query heads, the first group of query heads not grouped based on adjacency of neighboring query heads in the key value cache.

13. The apparatus of claim 8, wherein the non-grouped arrangement is a multi-head attention arrangement.

14. The apparatus of claim 8, wherein the amount of error is implemented by calculating a weight sharing error to indicate an expected drop in accuracy due to the error introduced by the grouping of query heads.

15. A method for grouping of query heads in a key value cache, the method comprising:
creating a plurality of groups of query heads present in a key value cache using an evolutionary algorithm based on at least two objectives;
quantifying an amount of error introduced by a first group of query heads in the plurality of groups of query heads; and
retaining the query heads of the first group of query heads in a non-grouped arrangement when the error meets an error threshold.

16. The method of claim 15, wherein a first objective of the evolutionary algorithm is an estimated impact on a size of the key value cache.

17. The method of claim 16, wherein a second objective of the evolutionary algorithm is an estimation of a resultant quality of an output of a model.

18. The method of claim 15, wherein the plurality of groups includes a first group of query heads having a first number of query heads and a second group of query heads having a second number of query heads different from the first number of query heads.

19. The method of claim 15, wherein the plurality of groups includes a first group of query heads having a first number of query heads and a second group of query heads having the first number of query heads, the first group of query heads not grouped based on adjacency of neighboring query heads in the key value cache.

20. The method of claim 15, wherein the non-grouped arrangement is a multi-head attention arrangement.
